(19) United States
(12) Patent Application Publication
(10) Pub. No.: US 2020/0065715 A1
(43) Pub. Date: Feb. 27, 2020

(54) SYSTEM AND METHODS TO DETERMINE CARRIER BASED ON TRACKING NUMBER

(71) Applicant: Walmart Apollo, LLC, Bentonville, AR (US)

(72) Inventors: Mingang Fu, Palo Alto, CA (US); Madhavan Kandhadai Vasantham, Dublin, CA (US); Shengyang Zhang, Santa Clara, CA (US); Anurag Gupta, Palo Alto, CA (US)

(21) Appl. No.: 16/114,138

(22) Filed: Aug. 27, 2018

(51) Int. Cl. G06N 99/00

(52) U.S. Cl. CPC G06N 99/005; G06Q 10/0838

(57) ABSTRACT

Systems and methods for obtaining resource information for a resource identifier are disclosed. A resource identifier associated with one of a plurality of resource providers is received from a source system. A clustering model including a plurality of clusters each associated with one of the plurality of resource providers is selected from a plurality of clustering models. A cluster in the clustering model having a least distance from the resource identifier is selected. A request for resource information including the resource identifier is generated and provided to a system associated with the one of the plurality of resource providers associated with the selected cluster.

### TECHNICAL FIELD

This application relates generally to resource identification, and more particularly, relates to identifying a resource provider based on a resource identifier.

### BACKGROUND

Current retail or other goods-delivery systems rely on shipping information to provide customers with notifications when an item has shipped, is in transit, and/or has arrived at a destination. Missing or incorrect carrier information for shipments originating from first party or third party shippers prevents this information from being transmitted to customers and/or used for internal tracking. For example, if the system has missing or incorrect carrier information, a tracking system may not be able to provide shipping updates to a customer.

Current carrier identification systems rely on hardcoded, resource intensive rules and API calls for identifying carrier information based on a tracking number or other unique identifier. Current carrier identification systems may call APIs associated with multiple carriers, with each carrier being selected based on hardcoded rules related to the tracking number. The carrier identification system will perform calls until a positive response that associates the tracking number with a specific carrier is received. The hardcoded rule application and API calls are resource intensive and each serial API call or rule application requires additional system resources and time.

### SUMMARY OF THE INVENTION

In various embodiments, a system is disclosed. The system includes a computing device configured to receive a resource identifier associated with one of a plurality of resource providers from an identifier source. The computing device selects a clustering model comprising a plurality of clusters each associated with one of the plurality of resource providers. The clustering model is selected from a plurality of clustering models. The computing device identifies, using the clustering model, a cluster in the clustering model having a least distance from the resource identifier. The computing device generates a request for resource information including the resource identifier. The request is provided to a system associated with the one of the plurality of resource providers associated with the identified cluster.

In various embodiments, a method is disclosed. The method includes a step of receiving, from an identifier source, a resource identifier associated with one of a plurality of resource providers, wherein the resource identifier comprises an alphanumeric string having a first length. A clustering model including a plurality of clusters each associated with one of the plurality of resource providers is selected from a plurality of clustering models based on the first length of the resource identifier. A cluster in the clustering model having a least distance from the resource identifier is selected and a request for resource information including the resource identifier is generated. The request is provided to a system associated with the one of the plurality of resource providers associated with the selected cluster.

In various embodiments, a non-transitory computer readable medium having instructions stored thereon is disclosed. The instructions, when executed by a processor cause a device to perform operations including receiving, from an identifier source, a resource identifier associated with one of a plurality of resource providers, wherein the resource identifier comprises an alphanumeric string having a first length. A clustering model including a plurality of clusters each associated with one of the plurality of resource providers is selected from a plurality of clustering models based on the first length of the resource identifier. A cluster in the clustering model having a least distance from the resource identifier is selected and a request for resource information including the resource identifier is generated. The request is provided to a system associated with the one of the plurality of resource providers associated with the selected cluster.

### BRIEF DESCRIPTION OF THE DRAWINGS

The features and advantages will be more fully disclosed in, or rendered obvious by the following detailed description of the preferred embodiments, which are to be considered together with the accompanying drawings wherein like numbers refer to like parts and further wherein:

FIG. 1 illustrates a block diagram of a computer system, in accordance with some embodiments.

FIG. 2 illustrates a networked environment configured to provide resource information to a requesting system based on a resource identifier, in accordance with some embodiments.

FIG. 3 is a flowchart illustrating a method of obtaining resource information from a resource provider based on a resource identifier, in accordance with some embodiments.

FIG. 4 illustrates a system flow of various steps of the method of FIG. 3, in accordance with some embodiments.

FIG. 5 is a flowchart illustrating a data partition step of the method of FIG. 3, in accordance with some embodiments.

FIG. 6 illustrates a method for training each of a plurality of clustering networks, in accordance with some embodiments.

FIG. 7 is a system flow illustrating various steps of the method of FIG. 6, in accordance with some embodiments.

FIG. 8 illustrates a truncated clustering model including a predetermined number of hierarchical clusters, in accordance with some embodiments.

FIG. 9 illustrates a heuristic method of determining a cutoff point for a clustering model, in accordance with some embodiments.

### DETAILED DESCRIPTION

The ensuing description provides preferred exemplary embodiment(s) only and is not intended to limit the scope, applicability or configuration of the disclosure. Rather, the ensuing description of the preferred exemplary embodiment(s) will provide those skilled in the art with an enabling description for implementing a preferred exemplary embodiment. It is understood that various changes can be made in the function and arrangement of elements without departing from the spirit and scope as set forth in the appended claims.

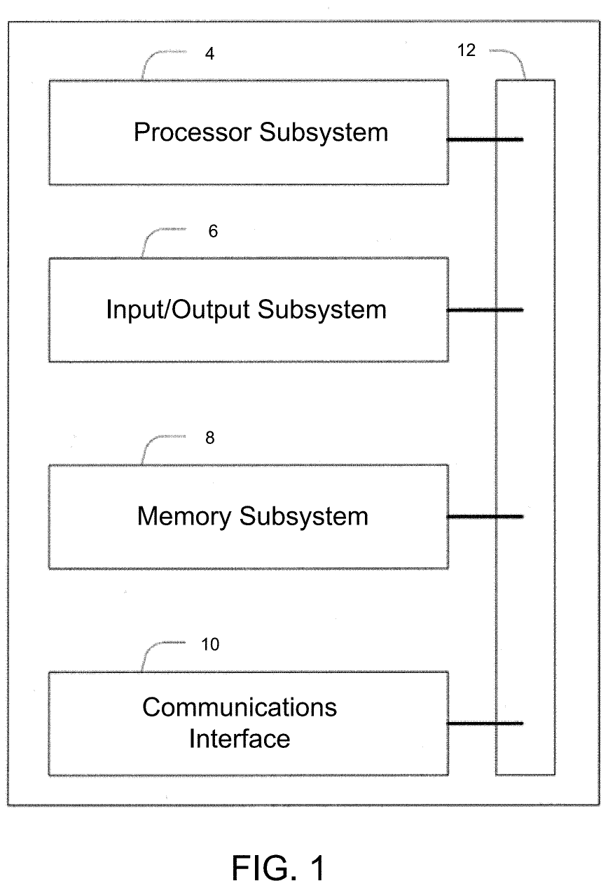

FIG. 1 illustrates a computer system configured to implement one or more processes, in accordance with some embodiments. The system 2 is a representative device and may comprise a processor subsystem 4, an input/output subsystem 6, a memory subsystem 8, a communications interface 10, and a system bus 12. In some embodiments, one or more than one of the system 4 components may be combined or omitted such as, for example, not including a input/output subsystem 6. In some embodiments, the system 2 may comprise other components not combined or comprised in those shown in FIG. 1. For example, the system 2 may also include, for example, a power subsystem. In other embodiments, the system 2 may include several instances of the components shown in FIG. 1. For example, the system 2 may include multiple memory subsystems 8. For the sake of conciseness and clarity, and not limitation, one of each of the components is shown in FIG. 1.

The processor subsystem 4 may include any processing circuitry operative to control the operations and performance of the system 2. In various aspects, the processor subsystem 4 may be implemented as a general purpose processor, a chip multiprocessor (CMP), a dedicated processor, an embedded processor, a digital signal processor (DSP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The processor subsystem 4 also may be implemented by a controller, a microcontroller, an application specific integrated circuit (ASIC), a field programmable gate array (FPGA), a programmable logic device (PLD), and so forth.

In various aspects, the processor subsystem 4 may be arranged to run an operating system (OS) and various applications. Examples of an OS comprise, for example, operating systems generally known under the trade name of Apple OS, Microsoft Windows OS, Android OS, Linux OS, and any other proprietary or open source OS. Examples of applications comprise, for example, network applications, local applications, data input/output applications, user interaction applications, etc.

In some embodiments, the system 2 may comprise a system bus 12 that couples various system components including the processing subsystem 4, the input/output subsystem 6, and the memory subsystem 8. The system bus 12 can be any of several types of bus structure(s) including a memory bus or memory controller, a peripheral bus or external bus, and/or a local bus using any variety of available bus architectures including, but not limited to, 9-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect Card International Association Bus (PCMCIA), Small Computers Interface (SCSI) or other proprietary bus, or any custom bus suitable for computing device applications.

In some embodiments, the input/output subsystem 6 may include any suitable mechanism or component to enable a user to provide input to system 2 and the system 2 to provide output to the user. For example, the input/output subsystem 6 may include any suitable input mechanism, including but not limited to, a button, keypad, keyboard, click wheel, touch screen, motion sensor, microphone, camera, etc.

In some embodiments, the input/output subsystem 6 may include a visual peripheral output device for providing a display visible to the user. For example, the visual peripheral output device may include a screen such as, for example, a Liquid Crystal Display (LCD) screen. As another example, the visual peripheral output device may include a movable display or projecting system for providing a display of content on a surface remote from the system 2. In some embodiments, the visual peripheral output device can include a coder/decoder, also known as Codecs, to convert digital media data into analog signals. For example, the visual peripheral output device may include video Codecs, audio Codecs, or any other suitable type of Codec.

In some embodiments, the communications interface 10 may include any suitable hardware, software, or combination of hardware and software that is capable of coupling the system 2 to one or more networks and/or additional devices. The communications interface 10 may be arranged to operate with any suitable technique for controlling information signals using a desired set of communications protocols, services or operating procedures. The communications interface 10 may comprise the appropriate physical connectors to connect with a corresponding communications medium, whether wired or wireless, such as a wired and/or wireless network.

In various aspects, the network may comprise local area networks (LAN) as well as wide area networks (WAN) including without limitation Internet, wired channels, wireless channels, communication devices including telephones, computers, wire, radio, optical or other electromagnetic channels, and combinations thereof, including other devices and/or components capable of/associated with communicating data. For example, the communication environments comprise various devices, and various modes of communications such as wireless communications, wired communications, and combinations of the same.

Wireless communication modes comprise any mode of communication between points (e.g., nodes) that utilize, at least in part, wireless technology including various protocols and combinations of protocols associated with wireless transmission, data, and devices. Wired communication modes comprise any mode of communication between points that utilize wired technology including various protocols and combinations of protocols associated with wired transmission, data, and devices. In various implementations, the wired communication modules may communicate in accordance with a number of wired protocols. Examples of wired protocols may comprise Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, to name only a few examples.

Accordingly, in various aspects, the communications interface 10 may comprise one or more interfaces such as, for example, a wireless communications interface, a wired communications interface, a network interface, a transmit interface, a receive interface, a media interface, a system interface, a component interface, a switching interface, a chip interface, a controller, and so forth. When implemented by a wireless device or within wireless system, for example, the communications interface 10 may comprise a wireless interface comprising one or more antennas, transmitters, receivers, transceivers, amplifiers, filters, control logic, and so forth.

In various aspects, the communications interface 10 may provide data communications functionality in accordance with a number of protocols. Examples of protocols may comprise various wireless local area network (WLAN) protocols, including the Institute of Electrical and Electronics Engineers (IEEE) 802.xx series of protocols, such as IEEE 802.11a/b/g/n, IEEE 802.16, IEEE 802.20, and so forth. Other examples of wireless protocols may comprise various wireless wide area network (WWAN) protocols, such as GSM cellular radiotelephone system protocols with GPRS, CDMA cellular radiotelephone communication systems with 1×RTT, EDGE systems, EV-DO systems, EV-DV systems, HSDPA systems, and so forth. Further examples of wireless protocols may comprise wireless personal area network (PAN) protocols, such as an Infrared protocol, a protocol from the Bluetooth Special Interest Group (SIG) series of protocols, including Bluetooth Specification versions v1.0, v1.1, v1.2, v2.0, v2.0 with Enhanced Data Rate (EDR), as well as one or more Bluetooth Profiles, and so forth. Yet another example of wireless protocols may comprise near-field communication techniques and protocols, such as electro-magnetic induction (EMI) techniques. An example of EMI techniques may comprise passive or active radio-frequency identification (RFID) protocols and devices. Other suitable protocols may comprise Ultra Wide Band (UWB), Digital Office (DO), Digital Home, Trusted Platform Module (TPM), ZigBee, and so forth.

In some embodiments, at least one non-transitory computer-readable storage medium is provided having computer-executable instructions embodied thereon, wherein, when executed by at least one processor, the computer-executable instructions cause the at least one processor to perform embodiments of the methods described herein. This computer-readable storage medium can be embodied in memory subsystem 8.

In some embodiments, the memory subsystem 8 may comprise any machine-readable or computer-readable media capable of storing data, including both volatile/non-volatile memory and removable/non-removable memory. The memory subsystem 8 may comprise at least one non-volatile memory unit. The non-volatile memory unit is capable of storing one or more software programs. The software programs may contain, for example, applications, user data, device data, and/or configuration data, or combinations therefore, to name only a few. The software programs may contain instructions executable by the various components of the system 2.

In various aspects, the memory subsystem 8 may comprise any machine-readable or computer-readable media capable of storing data, including both volatile/non-volatile memory and removable/non-removable memory. For example, memory may comprise read-only memory (ROM), random-access memory (RAM), dynamic RAM (DRAM), Double-Data-Rate DRAM (DDR-RAM), synchronous DRAM (SDRAM), static RAM (SRAM), programmable ROM (PROM), erasable programmable ROM (EPROM), electrically erasable programmable ROM (EEPROM), flash memory (e.g., NOR or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, disk memory (e.g., floppy disk, hard drive, optical disk, magnetic disk), or card (e.g., magnetic card, optical card), or any other type of media suitable for storing information.

In one embodiment, the memory subsystem 8 may contain an instruction set, in the form of a file for executing various methods, such as methods including resource identification, as described herein. The instruction set may be stored in any acceptable form of machine readable instructions, including source code or various appropriate programming languages. Some examples of programming languages that may be used to store the instruction set comprise, but are not limited to: Java, C, C++, C #, Python, Objective-C, Visual Basic, or .NET programming. In some embodiments a compiler or interpreter is comprised to convert the instruction set into machine executable code for execution by the processing subsystem 4.

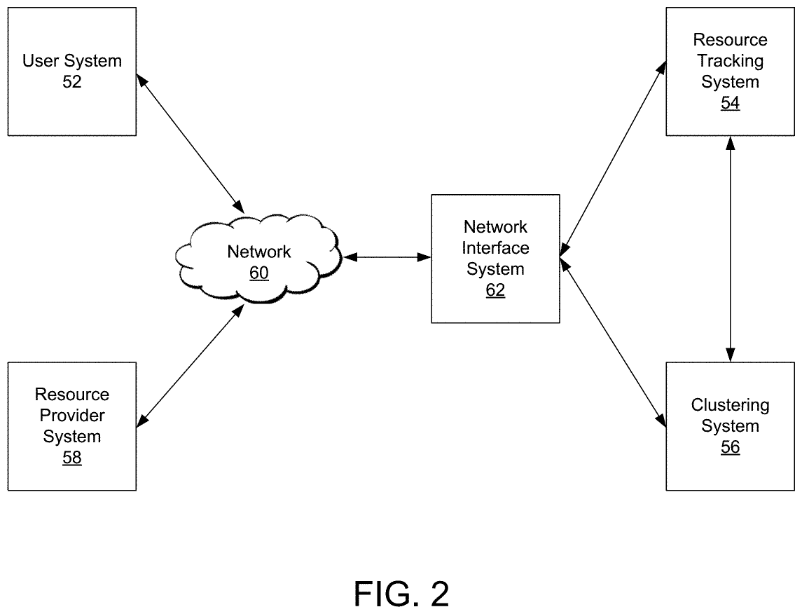

FIG. 2 illustrates a networked environment 50 configured to provide resource information regarding resource providers associated with a platform provider, in accordance with some embodiments. The networked environment 50 includes at least one user system 52, at least one resource tracking system 54, at least one clustering system 56, at least one resource provider system 58, and/or any other suitable systems. Each of the systems 52-58 can include a computer system, such as the computer system 2 described above in conjunction with FIG. 1. It will be appreciated that each of the systems 52-58 can include generic systems and/or special purpose systems, and are within the scope of this disclosure.

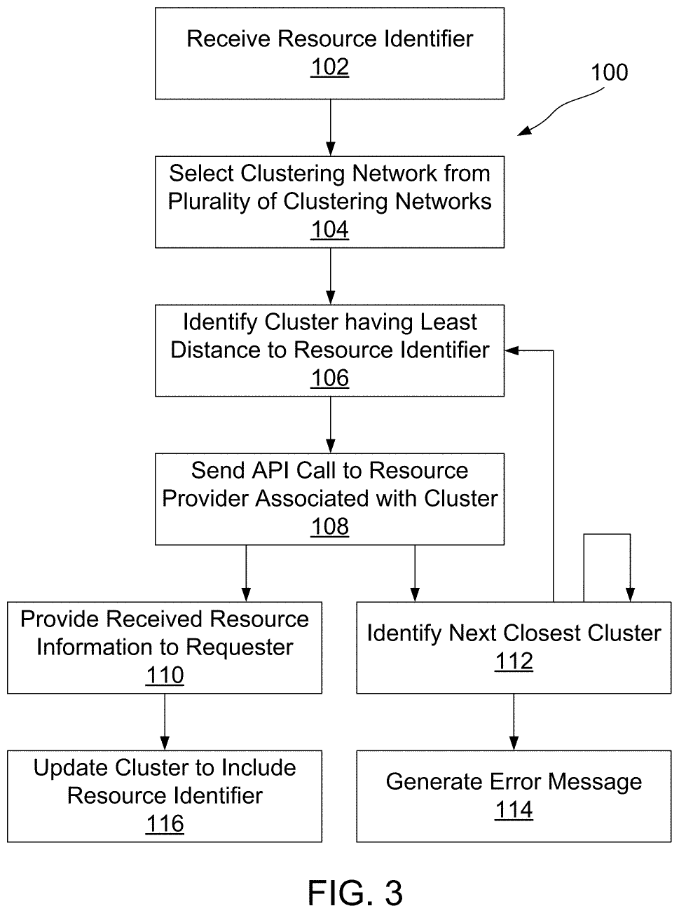

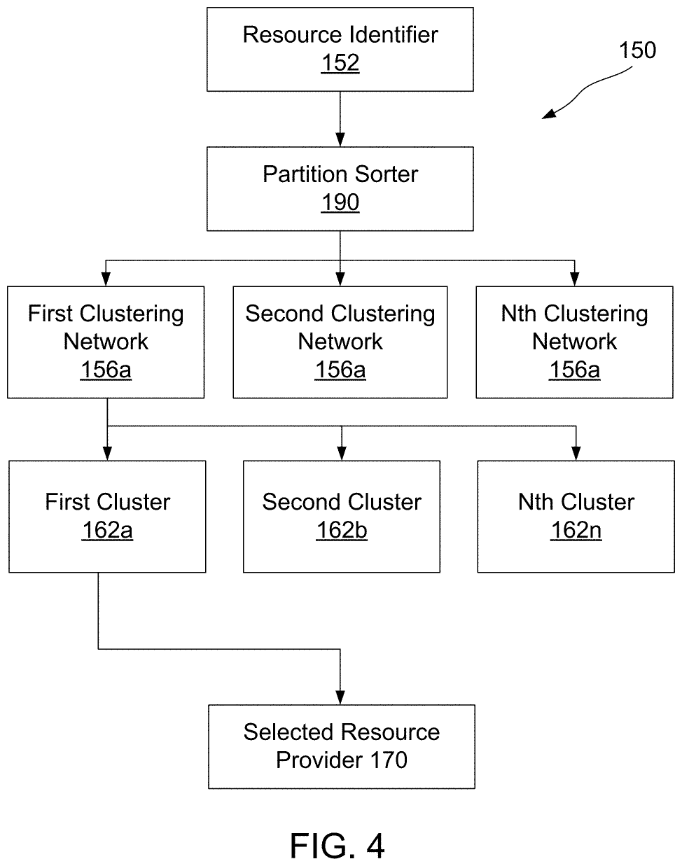

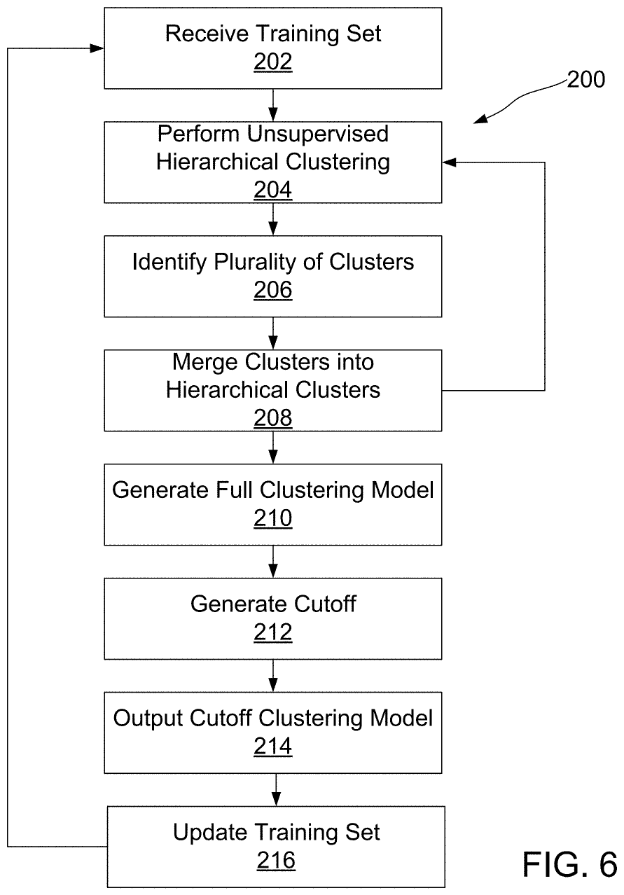

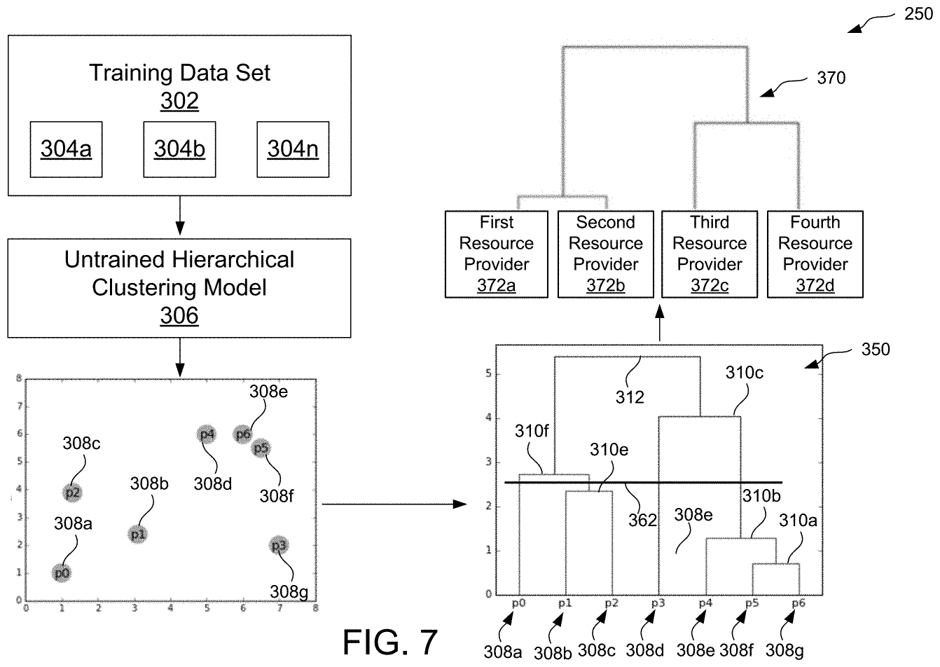

In some embodiments, each of the systems 52-58 are configured to exchange data over one or more networks, such as network 60. For example, in some embodiments, the user system 52 (and/or any other system) is configured to generate a request for resource information including a resource identifier which is provided to the resource tracking system 54. The resource tracking system 54 is configured to obtain a resource provider identity based on the resource identifier and generate an API request to the resource provider system 58, as discussed in greater detail below with respect to FIGS. 3-4. In some embodiments, the resource tracking system 54 uses one or more clustering models generated by the clustering system 56 to identify the resource provider associated with the provided resource identifier, as discussed in greater detail below with respect to FIGS. 6-7. After identifying the resource provider, the resource information system 54 generates an API call to the resource provider system 58 to obtain resource information, which is then provided back to the user system 52 that generated the original request. Although embodiments are discussed herein including specific systems and/or configurations, it will be appreciated that the networked environment 50 can include any number of systems, can combine one or more of the identified systems, and/or can include additional or alternative systems, in various embodiments.

FIG. 3 is a flowchart illustrating a method 100 of obtaining resource information from an unknown resource provider (such as a shipping carrier) based on a resource identifier (such as a tracking identifier), in accordance with some embodiments. FIG. 4 is a flow diagram 150 illustrating various steps of the method 100, in accordance with some embodiments. The method 100 is configured to allow a platform provider to identify a resource provider for an API call based on a resource identifier, generate the API call, receive resource information from the resource provider based on the resource identifier, and provide the resource information to a requesting system. The method 100 is further configured to allow resource providers, third parties, and/or the platform provider to implement new or adjusted resource identification schemes without needing to hardcode new or additional rules related to the resource identifiers.

At step 102, a resource identifier 152, such as a tracking identifier, is received by a resource tracking system 54. The resource identifier 152 can be received from any suitable requesting system, such as, for example, an external system (such as a user device 52), an internal system (such as a web server), and/or any other suitable source. The resource identifier 152 can be received from any suitable source, such as, for example, a user device 52, a database in signal communication and/or formed integrally with the resource tracking system 54, and/or any other suitable source. The resource identifier 152 includes a string of characters, such as, for example, alphanumeric characters, although it will be appreciated that any unique string may be used and is within the scope of this disclosure. The resource identifier 152 identifies a unique resource provided by the unknown resource provider. For example, in some embodiments, the resource identifier is a tracking identifier issued by a shipping carrier in conjunction with a specific shipment. Although embodiments are discussed herein including tracking identifiers and shipping carriers, it will be appreciated that the method 100 of obtaining resource information from an unknown resource provider can be applied to any resource identifier tracking any suitable resource.

In some embodiments, the resource identifier 152 is an alphanumeric string having a length within a predetermined range of possible lengths. One or more carriers may generate resource identifiers 152 having the same length. For example, in some embodiments, a first resource provider may generate resource identifiers of a first length, a second length, or a third length; a second resource provider may generate resource identifiers of a first length, a second length, and a fourth length; and a third resource provider may generate resource identifiers of a third length, a fourth length, and a fifth length. It will be appreciated that any number of resource providers can generate any number of resource identifiers having any length, and are within the scope of this disclosure.

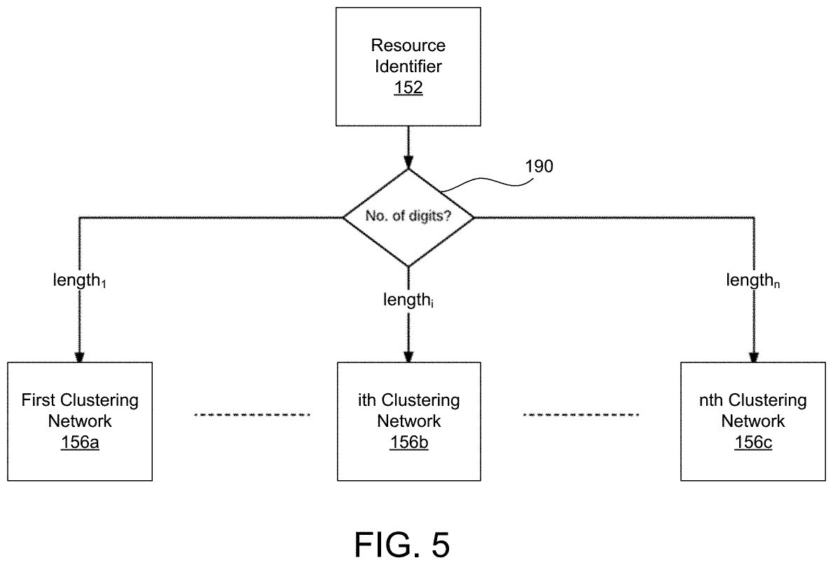

At step 104, a first clustering network 156a is selected from a plurality of clustering networks 158. The first clustering network 156a is associated with resource identifiers having a length equal to the length of the received resource identifier 152. For example, in some embodiments, a resource tracking system 54 can receive resource identifiers of various lengths from a lower bound to an upper bound, such as, for example, resource identifiers having lengths between 1-30 characters, 1-60 characters, 10-30 characters, etc. FIG. 5 illustrates a partitioning flow 190 for providing a received resource identifier 152 to a clustering network 156a-156n associated with the length (or partition) of the received resource identifier 152. The resource identifier 152 is provided to a partition sorter 190, which calculates a length of the received resource identifier 152. The partition sorter 190 selects one of a plurality of clustering networks 156a-156n based on the calculated length. The partition sorter 190 can be implemented by any suitable system, such as the resource tracking system 54, a clustering system 56, and/or any other suitable system. A clustering network 156a-156n is generated for each possible length of resource identifier 152, as discussed in greater detail below with respect to FIGS. 6-7. The length of the resource identifier can be an absolute length (i.e., the length of the character string) and/or a calculated length (e.g., the length of the character string minus spaces or other inconsequential characters).

At step 106, the clustering network 156a identifies a cluster 162a having the shortest distance (or least distance) between the received resource identifier 152 and the cluster 162a. Distance is used herein to refer to the similarity (or differences) between two or more resource identifiers 152. In some embodiments, the distance between the received resource identifier 152 and each cluster 162a-162n can be calculated as the average distance from the received resource identifier 152 to each element (e.g., resource identifier) within the cluster 162a-162n. For example, the average distance d between a resource identifier 152 and a cluster 162a-162n can be calculated as:

$${d}_{i , j} = \frac{{\sum }_{k = 1}^{k = \vert {c}_{j} \vert} {LL}_{i , k}}{\vert {c}_{j} \vert} \qquad ( Equation 1 )$$

wherein LL is the distance between a specific element (i) (e.g., resource identifier) in the cluster (j) 162a-162n and the received resource identifier 152 and c is the number of elements within the cluster 162a-162n. Each cluster 162a-162n has a resource provider associated therewith. For example, and as discussed in greater detail below, each cluster 162a-162n is tagged with a resource provider associated with the majority of resource identifiers within the cluster 162a-162n.

At step 108, an API call is performed by the resource tracking system to a resource provider system 58 provided by the resource provider 170 associated with a selected cluster 162a (i.e., the cluster 162a having the least distance to the resource identifier 152). The API call includes a request for additional information regarding the resource associated with the resource identifier. For example, in embodiments including a tracking identifier associated with a shipping carrier, the API call can be configured to retrieve shipping status, shipping updates, delivery estimates, delay information, and/or other information associated with one or more packages associated with the tracking identifier. If the API call is successful, the method 100 proceeds to step 110. If the API call is unsuccessful, the method 100 proceeds to step 112.

At step 110, if the API call was successful, the resource information is received from the resource provider system 58 and at least a portion of the resource information is provided to the requesting system. The resource information can include any suitable information associated with the resource identifier and/or the resource provider, such as, for example, shipping information associated with a package. In some embodiments, the method 100 then proceeds to step 116.

At step 112, the if the API call was unsuccessful (i.e., the API system 170 indicates that the resource identifier 152 is not associated with the selected resource provider), the selected resource provider and the associated cluster 162a are identified as incorrect and the method 100 identifies a next closest cluster 162b. In some embodiments, the next closest cluster 162b is a cluster 162a-162c having the next shortest distance from the resource identifier 152. If the next closest cluster 162b is associated with a different resource provider than the previously identified cluster 162a, the method 100 returns to step 108 and generates an API call to an API server associated with the new resource provider. If the API call is successful, the method 100 proceeds to step 110. If the API call is unsuccessful, the method 100 repeats step 112, excluding each subsequently identified cluster 162a-162n until the correct resource provider (or API interface) is identified and/or all possible resource providers have been tried unsuccessfully. If all resource providers are tried unsuccessfully, the method 100 proceeds to step 114, an error message is generated indicating that the resource identifier is not associated with a known carrier, and the method 100 exits.

At step 116, the resource identifier and the selected cluster 162a are provided back to the first clustering network 156a to update the clustering network 156a. For example, and as discussed in greater detail below, each clustering network 156a-156n in the plurality of clustering networks 158 is generated by a machine learning process. For each received resource identifier 152 that is successfully associated with a resource provider, the clustering model 156a-156n can increase the accuracy of existing clusters and/or generate new clusters associated with a resource provider. In some embodiments, the update process may be initiated for each received resource identifier 152 and/or may be performed as a batch update process after a predetermined number of resource identifiers have been identified by the resource tracking system 154.

FIG. 6 illustrates a method 200 for training each of a plurality of clustering networks 156a-156n, in accordance with some embodiments. FIG. 7 is a system flow 250 illustrating various steps of the method 200, in accordance with some embodiments. At step 202, a training set 302 including a plurality of resource identifiers 304a-304n is received at an untrained hierarchical clustering model 306. Each resource identifier 304a-304n is associated (or tagged) with one of a plurality of resource providers. The untrained hierarchical clustering model 306 can be implemented by any suitable system, such as, for example, the clustering system 56. In some embodiments, each of the plurality of resource identifiers 304a-304n have the same length (e.g., represent a single partition of possible resource identifier lengths). The untrained hierarchical clustering model 306 is configured to generate a clustering network 156a-156n for the specific partition of resource identifiers 304a-304n in the training data set 302. In some embodiments, a trucated clustering network 156a-156n is generated for each partition of resource identifiers using a training set 302 including resource identifiers 304a-304n having a selected length.

At step 204, the untrained hierarchical clustering model 306 executes a clustering process to generate a similarity matrix 309. The similarity matrix indicates the similarity (or distance) between each of the resource identifiers 304a-304n. The untrained hierarchical clustering model 306 generates clusters 308a-308g based on the distance between each resource identifier 304a-304n in the training set 302. For example, in some embodiments, the distance (d) between two resource identifiers (T0, T1) having a length n is calculated as:

d=α₁*ƒ(T0₁,T1₁)+α₂*ƒ(T0₂,T1₂)+ . . . +αₙ*ƒ(T0ₙ,T1ₙ) (Equation 2)

wherein α₁, α₂ . . . αₙ are weighting coefficients, T0₁ and T1₁ are the ith digit of the corresponding resource identifier T0, T1, and ƒ is a distance function. In some embodiments, the weighting coefficients α₁, α₂ . . . αₙ are determined by a logistic regression. For example, in some embodiments, for each pair of resource identifiers (T0, T1) with length n, coefficients are calculated using equation 3 if T0 and T1 have the same carrier and otherwise are calculated using equation 4:

α₁*ƒ(T0₁,T1₁)+α₂*ƒ(T0₂,T1₂)+ . . . +αₙ*ƒ(T0ₙ,T1ₙ)=0 (Equation 3)

α₁*ƒ(T0₁,T1₁)+α₂*ƒ(T0₂,T1₂)+ . . . +αₙ*ƒ(T0ₙ,T1ₙ)=1 (Equation 4)

The distance function ƒ can be any suitable distance function. For example, in some embodiments, the distance function ƒ is defined as:

$$f ( x ) = \{ \begin{matrix}0 , T {0}_{i} = T {1}_{i} \\ 1 , T {0}_{i} \neq T {1}_{i} , \text{but both are numbers or both are letters} \\ 2 , T {0}_{i} \neq T {1}_{i} , \text{one is a number and one is a letter}\end{matrix} \qquad ( Equation 5 )$$

A logistical regression algorithm is used to combine each of the calculated weighted coefficients to generate a set of weighted coefficients for the clustering network 156a-156n. The untrained hierarchical clustering model 306 calculates the distance between each resource identifier 304a-304n using the set of weighted coefficients to generate the similarity matrix.

At step 206, a plurality of clusters 308a-308g are identified based on the similarity matrix 309 and tagged with a resource provider. Each of the clusters 308a-308g contains a subset of the resource identifiers 304a-304n in the training set 302. In some embodiments, a resource provider is associated with a selected cluster 308a-308g when a predetermined percentage of the resource identifiers 304a-304n in the cluster 308a-308g is associated with one of the resource providers. For example, in some embodiments, if more than 50% (i.e., a majority) of the resource identifiers 304a-304n in a cluster 308a-308g are tagged with the same resource provider, the cluster 308a-308g is tagged with that same resource provider. Although embodiments are discussed herein using a 50% threshold, it will be appreciated that the threshold can be any value that provides sufficient confidence in the association between the cluster 308a-308g and a resource provider.

At step 208, two or more of the clusters 308a-308g are merged together to form hierarchical clusters 310a-310e. The clusters 308a-308g are merged (or combined) until a predetermined number of clusters are identified. The clusters 308a-308g may be combined by selecting two clusters having a shortest (or least) average distance between. The shortest average distance may be calculated based on the average distance of each resource identifier 304a-304n in each of the clusters 308a-308g, a distance between a center of each of the clusters 308a-308g, and/or according to any other suitable method. For example, in the illustrated embodiment, an interim clustering model 350 having seven clusters 308a-308g is generated at step 206. At step 208, the sixth cluster 308f and the seventh cluster 308g, which are located at a shortest distance apart out of all clusters 308a-308g, are merged into a first hierarchical cluster 310a.

In some embodiments, the resource tracking system 154 (and/or other suitable system) may iteratively combine clusters 308a-308g and/or hierarchical clusters 310a-310e until the interim clustering network 350 contains a predetermined number of clusters, such as, for example, one cluster. For example, and with reference again to the illustrated embodiment, distance between the remaining clusters, e.g., the first, second, third, fourth, and fifth clusters 308a-308e and the first hierarchical cluster 310a is calculated. The shortest (or least) distance is between the fifth cluster 308e and the first hierarchical cluster 310a, which are combined into a second hierarchical cluster 310b. Another distance calculation is performed, and the second hierarchical cluster 310b is then combined with the fourth cluster 308d to generate a third hierarchical cluster 310c.

Similarly, the second and third clusters 308b, 308c are merged into a fourth hierarchical cluster 310d, which is merged with the first cluster 308a to generate a fifth hierarchical cluster 310e. The third hierarchical structure 310c and the fifth hierarchical structure 310e are then merged into a single cluster 312 containing all of the resource identifiers 304a-304n in the training set 302.

The method 200 repeats steps 204-208 a predetermined number of times. During each subsequent iteration, a new and/or modified clustering model 350 is generated. After a predetermined number of iterations are complete, the method 200 proceeds to step 210 and a full clustering model 350 is generated by combining the interim clustering models 350. The full clustering model 350 includes a number of clusters 308a-308g and a number of hierarchical structures 310a-310e, 312.

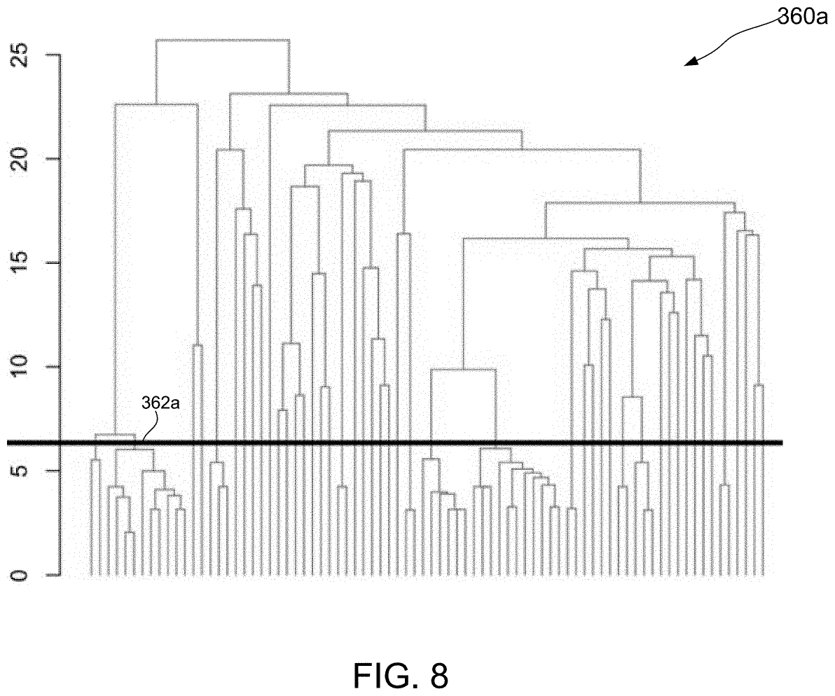

At step 212, a cluster cutoff 362 is generated for the full clustering model 350. The cluster cutoff 362 indicates a position within the full clustering model 350 at which the number of hierarchical clusters 310a-310g is sufficient to identify resource identifiers 304a-304n associated with each resource provider included in the training data set 302 for the current partition. For example, as shown in FIG. 8, in some embodiments, a full clustering model 350a includes a plurality of clusters 308 including 80 clusters. The clustering model 350a is truncated at a cutoff 362a at which the plurality of clusters 308 have been combined (i.e., merged) into 40 hierarchical clusters (e.g., the dendogram tree of the clustering model 350a is cutoff at a point 362a which results in 40 distinct hierarchical clusters). The 40 distinct clusters are sufficient for resource provider identification above a predetermined threshold, as discussed in greater detail below. Although the illustrated embodiment includes a cutoff 362a resulting in 40 hierarchical clusters, it will be appreciated that the cutoff 362a can be selected such that a final clustering model 156a-156n includes any number of hierarchical and/or non-hierarchical clusters (e.g., one or more combined clusters and/or one or more uncombined clusters). In some embodiments, a cross-validation technique is configured to automatically select a cutoff 362 for a full clustering model 350.

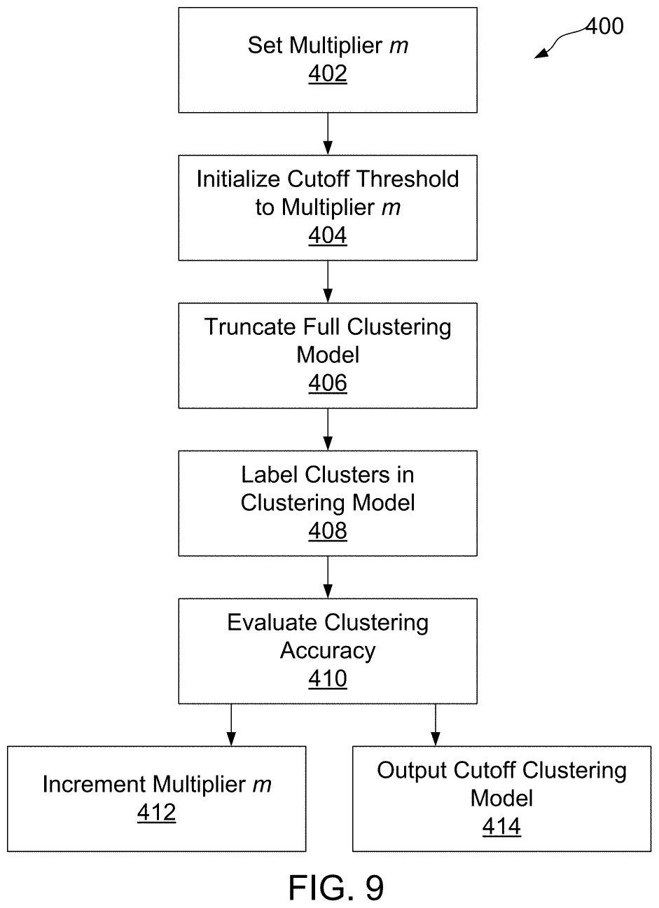

In some embodiments, the cutoff 362 is determined by a heuristic method 400, as illustrated in FIG. 9. At step 402, a multiplier m is set. The multiplier m is initially equal to the number of resource providers included in the training data set 302 (e.g., if there are five resource providers associated with the resource identifiers 304a-304n, m is equal to five). For example, in embodiments including tracking identifiers, the multiple m is initially set to the number of carriers that use a tracking identifier having a length equal to an identifier length associated with the current partition, although it will be appreciated that m can have a different initial value, such as, for example, a value equal to the number of total resource providers that provide a specific resource (e.g., shipping) to a provider.

At step 404, a cutoff threshold n_{cluster} is initialized with a value equal to m, i.e.:

n_{cluster}=m

In the illustrated embodiment, n_{cluster} is equal to the number of resource providers (e.g., carriers) included in the training data set 302 for the current partition. At step 406, a full clustering model 350 is truncated at cutoff 362 such that the cutoff clustering model 370 includes a number of clusters equal to n_{cluster} (as shown in FIG. 7).

At step 408, each cluster 308a-308d in the cutoff clustering model 370 is labeled with a resource provider identity 372a-372d (e.g., name, API address, etc.). The resource provider identity 372a-372d is selected such that a predetermined number or percentage (e.g., a majority) of the resource identifiers 304a-304n in a selected cluster 308a-308d are associated with the resource provider. Each resource identifier 304a-304n in the cluster 308a-308d is subsequently retagged with the selected resource provider (despite the potential presence of some resource identifiers not associated with the selected resource provider in the cluster 308a-308d).

At step 410, the clustering accuracy for the cutoff clustering model 370 is evaluated. In some embodiments, the clustering accuracy is evaluated according to the equation:

$$\text{clustering accuracy} = \frac{\text{No. of Correctly Identified Resource Identifiers}}{\text{Total Number of Resource Identifiers}}$$

In some embodiments, if the clustering accuracy is less than a predetermined threshold value and m is less than the total number of resource identifiers 304a-304n in the training set (M), the method 400 proceeds to step 412. If the clustering accuracy is above a predetermined threshold or m is equal to M, the method 400 proceeds to step 414.

At step 412, the multiplier m is incremented by a predetermined value. For example, in the illustrated embodiment, m is incremented by one, e.g., m=m+1. After incrementing the multiplier m, the method 400 returns to step 404 and a new cutoff threshold is generated and validated. At step 414, the method 400 outputs the cutoff clustering model 370 as a final clustering model for the current partition. In some embodiments, at step 416, cross-validation is used to identify the predetermined threshold value for evaluating clustering accuracy.

With reference again to FIG. 6, at step 214, a cutoff clustering model 370 is output as a final clustering model 156a-156n associated with the current partition. The final clustering model 156a-156n is provided to the resource tracking system 54 for use in the method 100, as discussed in greater detail above. In some embodiments, final clustering models 156a-156n are generated only for a subset of partitions containing a predetermined number of possible carriers. In other embodiments, final clustering models 156a-156n are generated for all possible partitions (e.g., resource identifier 152 lengths) that can be received by the resource tracking system 154.

At step 216, the training data set 302 is updated and a new clustering model 156a-156n is generated for a partition. The training data set 302 is updated to include resource tracking identifiers 152 successfully identified by the resource tracking system 54 using the current final clustering model 156a-156n associated with a selected partition. The updated training data set 302 includes each of the identified resource tracking identifiers and an associated resource provider (e.g., associated API system) that was successfully associated with the resource tracking identifier 152. In some embodiments, one or more existing resource identifiers in the training data set 302 are replaced with resource identifiers 152 identified by the resource tracking system 54. The clustering system 56 generates a new final clustering model 156a-156n according to the method 200 using the updated training data set. The training data set 302 can be updated and a new/updated clustering model generated at a predetermined interval, for example, biweekly, although it will be appreciated that any suitable retraining interval can be used. Training data set updates and new model generation can be implemented by the clustering system 56, a separate update system (not shown), and/or any other suitable system.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A system, comprising:
a computing device configured to:
receive, from an identifier source, a resource identifier associated with one of a plurality of resource providers;
select a clustering model comprising a plurality of clusters each associated with one of the plurality of resource providers, wherein the clustering model is selected from a plurality of clustering models;
select, using the clustering model, a cluster having a least distance from the resource identifier;
generate a request for resource information including the resource identifier, wherein the request is provided to a system associated with the one of the plurality of resource providers associated with the selected cluster.

2. The system of claim 1, wherein the computing device is configured to select a clustering model based on a length of the resource provider.

3. The system of claim 2, wherein the clustering model is selected using a partitioning model.

4. The system of claim 1, wherein the clustering model is generated by an unsupervised clustering algorithm.

5. The system of claim 4, wherein the unsupervised clustering algorithm is configured to generate a plurality of clusters based on a distance between each resource identifier in a predetermined set of resource identifiers.

6. The system of claim 5, wherein the distance (d) between each resource identifier is calculated as:
d=α₁*ƒ(T0₁,T1₁)+α₂*ƒ(T0₂,T1₂)+ . . . +αₙ*ƒ(T0ₙ,T1ₙ)
wherein α₁, α₂ . . . αₙ are weighting coefficients, T0ᵢ and T1ᵢ are an ith digit of a corresponding resource identifier T0, T1, and ƒ is a distance function.

7. The system of claim 6, wherein the weighting coefficients α₁, α₂ . . . αₙ are determined using equations each pair of resource identifiers (T0, T1) with length n, coefficients are calculated as:
α₁*ƒ(T0₁,T1₁)+α₂*ƒ(T0₂,T1₂)+ . . . +αₙ*ƒ(T0ₙ,T1ₙ)=0
when the resource identifiers T0, T1 share a carrier and
α₁*ƒ(T0₁,T1₁)+α₂*ƒ(T0₂,T1₂)+ . . . +αₙ*ƒ(T0ₙ,T1ₙ)=1
when the resource identifiers T0, T1 have different carriers.

8. The system of claim 6, wherein the distance function ƒ is:
$$f ( x ) = \{ \begin{matrix}0 , & T {0}_{i} = T {1}_{i} \\ 1 , & T {0}_{i} \neq T {1}_{i} , \text{but both are numbers or both are letters} \\ 2 , & T {0}_{i} \neq T {1}_{i} , \text{one is a number and one is a letter}\end{matrix}$$

9. The system of claim 4, wherein the unsupervised clustering model generates a full clustering model having a predetermined number of hierarchical clusters, and wherein each of the plurality of clustering models is generated by truncating the full clustering model at a cutoff threshold.

10. The system of claim 9, wherein the cutoff point is determined based on clustering accuracy, wherein the clustering accuracy is evaluated by:
$$\text{clustering accuracy} = \frac{\text{A Number of Correctly Identified Resource Identifiers}}{\text{A Total Number of Resource Identifiers}} .$$

11. The system of claim 1, wherein a distance (d_{i,j}) between the resource identifier and each cluster (j) in a clustering model is calculated as:
$${d}_{i , j} = \frac{{\sum }_{k = 1}^{k = \vert {c}_{j} \vert} {LL}_{i , k}}{\vert {c}_{j} \vert}$$
wherein LL is the distance between the resource identifier and an ith element of the cluster (j).

12. A method, comprising
receiving, from an identifier source, a resource identifier associated with one of a plurality of resource providers, wherein the resource identifier comprises an alphanumeric string having a first length;
selecting a clustering model comprising a plurality of clusters each associated with one of the plurality of resource providers, wherein the clustering model is selected from a plurality of clustering models based on the first length of the resource identifier;
selecting, using the clustering model, a cluster in the clustering model having a least distance from the resource identifier;
generating a request for resource information including the resource identifier, wherein the request is provided to a system associated with the one of the plurality of resource providers associated with the selected cluster.

13. The method of claim 12, wherein the clustering model is selected using a partitioning model.

14. The method of claim 12, wherein the clustering model is generated by an unsupervised clustering algorithm.

15. The method of claim 14, wherein the unsupervised clustering algorithm is configured to generate a plurality of clusters based on a distance between each resource identifier in a predetermined set of resource identifiers.

16. The method of claim 15, wherein the distance (d) between each resource identifier is calculated as:
d=α₁*ƒ(T0₁,T1₁)+α₂*ƒ(T0₂,T1₂)+ . . . +αₙ*ƒ(T0₁,T1ₙ)
wherein α₁, α₂ . . . αₙ are weighting coefficients, T0ᵢ and T1ᵢ are an ith digit of a corresponding resource identifier T0, T1, and ƒ is a distance function.

17. The method of claim 16, wherein the weighting coefficients α₁, α₂ . . . αₙ are determined using equations each pair of resource identifiers (T0, T1) with length n, coefficients are calculated as:
α₁*ƒ(T0₁,T1₁)+α₂*ƒ(T0₂,T1₂)+ . . . +αₙ*ƒ(T0ₙ,T1ₙ)=0
when the resource identifiers T0, T1 share a carrier and
α₁*ƒ(T0₁,T1₁)+α₂*ƒ(T0₂,T₂)+ . . . +αₙ*ƒ(T0ₙ,T1ₙ)=1
when the resource identifiers T0, T1 have different carriers, and wherein the distance functionf is:
$$f ( x ) = \{ \begin{matrix}0 , & T {0}_{i} = T {1}_{i} \\ 1 , & T {0}_{i} \neq T {1}_{i} , \text{but both are numbers or both are letters} \\ 2 , & T {0}_{i} \neq T {1}_{i} , \text{one is a number and one is a letter}\end{matrix}$$

18. The system of claim 14, wherein the unsupervised clustering model generates a full clustering model having a predetermined number of hierarchical clusters, and wherein each of the plurality of clustering models is generated by truncating the full clustering model at a cutoff threshold, wherein the cutoff point is determined based on clustering accuracy evaluated by:
$$\text{clustering accuracy} = \frac{\text{A Number of Correctly Identified Resource Identifiers}}{\text{A Total Number of Resource Identifiers}} .$$

19. The system of claim 12, wherein a distance (d_{i,j}) between the resource identifier and each cluster (j) in a clustering model is calculated as:
$${d}_{i , j} = \frac{{\sum }_{k = 1}^{k = \vert {c}_{j} \vert} {LL}_{i , k}}{\vert {c}_{j} \vert}$$
wherein LL is the distance between the resource identifier and an ith element of the cluster (j).

20. A non-transitory computer readable medium having instructions stored thereon, wherein the instructions, when executed by a processor cause a device to perform operations comprising:
receiving, from an identifier source, a resource identifier associated with one of a plurality of resource providers, wherein the resource identifier comprises an alphanumeric string having a first length;
selecting a clustering model configured to identify a selected one of the plurality of resource providers, wherein the clustering model is selected from a plurality of clustering models, wherein the clustering model is associated with the first length of the resource identifier;
identifying, using the clustering model, a cluster of known resource identifiers in the clustering model having a least distance from the resource identifier, wherein the cluster is associated with a known one of the plurality of resource providers;
generating a request for resource information including the resource identifier, wherein the request is provided to a system associated with the known one of the plurality of resource providers.
